(19) United States
(12) Patent Application Publication
(10) Pub. No.: US 2002/0130755 A1
(43) Pub. Date: Sep. 19, 2002

(54) Protector device

(76) Inventors: Yoshiaki Takasugi, Gotenba-shi (JP); Mitsuru Unno, Mishima-shi (JP); Takashi Masuda, Susono-shi (JP)

Correspondence Address: Russell E. Baumann, Texas Instruments Incorporated, MS 20-21, 34 Forest St., Attleboro, MA, 02703, US

(21) Appl. No.: 10/092,781

(22) Filed: Mar. 7, 2002

(30) Foreign Application Priority Data
Mar. 19, 2001 (JP) 2001-077537

(51) Int. Cl. H01H 37/52; H01H 37/04

(52) U.S. Cl. 337/333; 337/362; 337/380

(57) ABSTRACT

A protector device (1) has a fixed electrode plate (12) with a fixed contact (12b) attached thereto and a movable electrode plate (14) with a movable contact (14b) attached thereto in which the movable contact (14b) is positioned to be able to make and break contact with the fixed contact (12b). A snap acting thermally responsive bimetallic member (15) is positioned adjacent the movable electrode plate (14) and is movable from a first position to a second position upon being heated to a prescribed temperature for causing either the engagement or disengagement of said fixed contact (12b) and said movable contact (14b). Additionally, an insulator member (13) is provided to insulate said movable electrode (14) and said bimetal member (15) from said fixed electrode plate (12) and an attachment member (17) is used to securely fix both the movable electrode (14) and the bimetal member (15) on the insulator (13).

### FIELD OF THE INVENTION

This invention relates to protector devices which by way of example are used to protect a motor.

### BACKGROUND OF THE INVENTION

It has been known in the prior art to use a protector device to protect a device from overheating in operation. An example of one such protector device 100 is shown in FIG. 11. Protector 100 is connected by electric wires to a power source circuit of a device such as a motor (not shown). It comprises a fixed electrode plate 102 that has affixed thereto a fixed contact member 101 and a movable electrode plate 104 that has a movable contact member 103 fixed thereto.

A temperature responsive bimetal member 105 is positioned within protector 100 so as to be able to engage movable electrode plate 104 upon being heated and reaching a predetermined activation temperature. An insulating member 106 is interposed between movable electrode plate 104 and bimetal member 105 and fixed electrode plate 102. All these items are inserted into housing 120.

In normal operation of the protector fixed contact 101 and movable contact 103 are in engagement with one another thereby closing the power circuit to supply electrical power to the device being protected. Upon the protected device becoming overheated, such heat will cause the bimetal member 105 to actuate thereby moving movable contact 103 out of engagement from fixed contact 101 and opening power source circuit.

One variation of the above described example would be to hold movable electrode plate 104 and bimetal member 105 together by the use of metal plates 107 and 108 which are soldered together (see FIG. 11). Another variation is shown in FIG. 10 (protector 100′) which modifies insulator 106 to include protuberant portion 106a for holding movable electrode plate 104 and bimetal member 105 together.

In all of the above described prior art examples, reliability problems can occur due to loosening of the fixed attachment of movable electrode plate 104 and bimetallic member 105. This loosening can occur due to vibration, heating/cure problems, prior soldering, etc., which will yield a protector of lowered reliability.

### SUMMARY OF THE INVENTION

Accordingly, the purpose of this invention is to solve the problems of prior art protection devices by providing a highly reliable protector device by ensuring that the positioning of the various components and especially the movable electrode and bimetal member are securely fixed, one relative to the others. There needs to be no slippage among the component at the point of attachment.

Briefly stated, an electrical protection device according to this invention comprises a fixed electrode that has a fixed contact mounted thereon, a movable electrode that has a movable contact mounted thereon, said movable contact positioned to be able to make and to break contact with said fixed contact, a heat responsive bimetal member positioned directly adjacent said movable electrode which moves from a first position to a second position upon being heated to a prescribed temperature for causing either the engagement or the disengagement of said fixed contact and said movable contact, an insulator member which electrically insulates both said movable electrode and said bimetal member from said fixed electrode and an attachment member capable of being inserted into part of said insulator to securely fix both said movable electrode and said bimetal member on said insulator at an attachment point thereby allowing for essentially no relative movement between the movable electrode and the bimetal member at said attachment point.

In accordance with this invention, it is desirable that the fixed electrode and insulator are integrally formed together.

In accordance with one embodiment of this invention, the fixed electrode has an opening therein for receiving the attachment member and a deformed electricity carrying portion having sufficient size to carry a prescribed electric current without overheating while maintaining a prescribed insulation distance from the attachment member.

Additional objects and features of the invention will be set forth in part in the description which follows and in part will be obvious from the description. The objects and advantages of the invention may be realized and attained by means of the instrumentalities, combinations and articles particularly pointed out in the appended claims.

### BRIEF DESCRIPTION OF THE DRAWINGS

The accompanying drawings in and constituted as part of the specification illustrate a preferred embodiment of the invention and, together with the description, serve to explain the objects, advantages and principles of the invention. In the drawings:

FIG. 1 shows a partial cross sectional front view of a protector made in accordance with a preferred embodiment of the invention;

FIGS. 2(a) and 2(b) show a top view and a front cross sectional view respectively of a protector assembly of the protector of FIG. 1;

FIGS. 3(a) through 3(c) show a top view, a front cross sectional view and a bottom view respectively of the fixed electrode member of the protector assembly of FIGS. 2(a) and 2(b);

FIGS. 4(a) and 4(b) show a cross sectional front view and a bottom view respectively of the fixed electrode plate used in the protector of FIG. 1;

FIGS. 5(a) and 5(b) show a top view and a front cross sectional view of a respectively holding member used in the protector of FIG. 1;

FIGS. 6(a) and 6(b) show the method for attaching together the protector assembly;

FIGS. 7(a) and 7(b) show a cross sectional front view and a cross sectional side view respectively of an essential part of the protector shown in FIG. 1;

FIGS. 8(a) and 8(b) show a cross sectional front view and a cross sectional side view respectively of an essential part of a second embodiment of the protector of this invention;

FIGS. 9(a) and 9(b) show a cross sectional front view and a cross sectional side view respectively of an essential part of a third embodiment of the protector of this invention;

FIG. 10 shows a partial cross sectional front view of a protector according to prior art; and

FIG. 11 shows a partial cross sectional front view of another protector according to prior art.

### BRIEF DESCRIPTION OF PREFERRED EMBODIMENTS

As is shown in FIG. 1, a protector 1 according to a first embodiment of this invention is connected to a power circuit for a motor or the like (not shown) by two electric wires 2 and 3. Protector 1 comprises a protector assembly 10 and a protector casing 20.

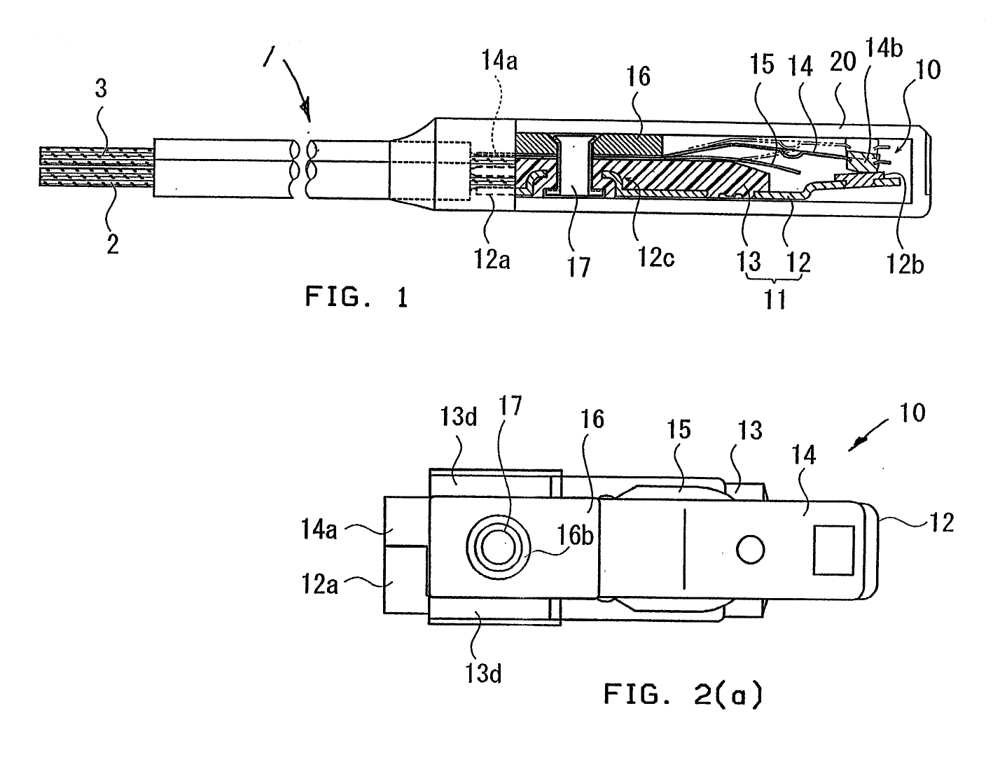

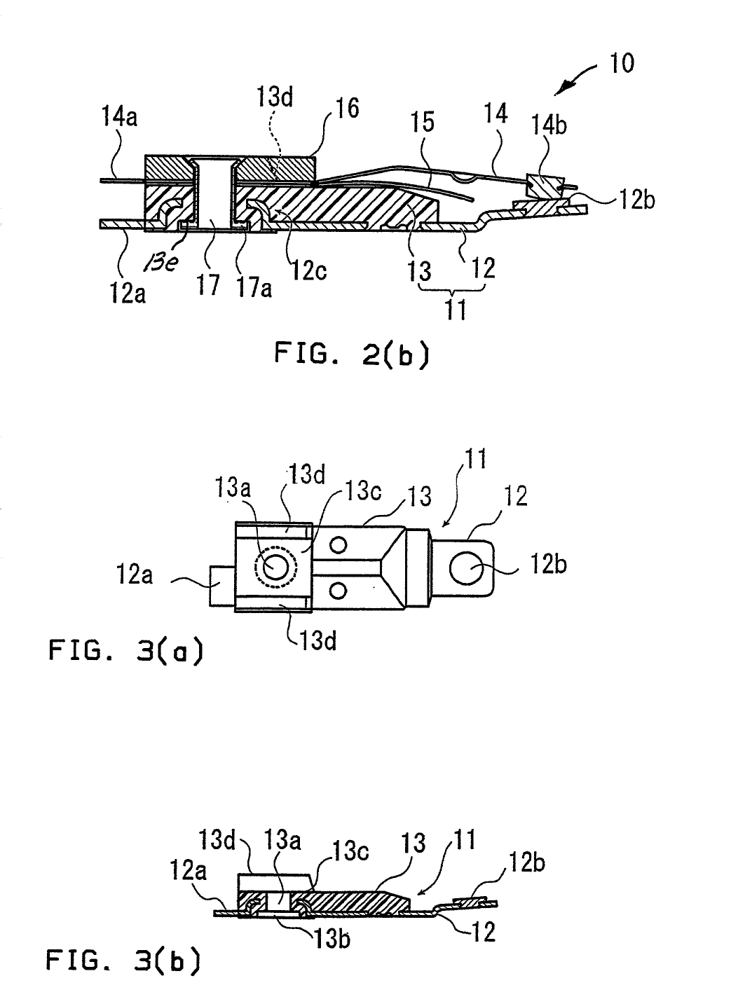

As is shown in FIGS. 2(a) and 2(b), protector assembly 10 has a fixed electrode member 11, a movable electrode member 14, a bimetal member 15 and a holding member which are joined together by an attachment means 17 such as a rivet or the like. Moreover, fixed electrode 11 comprises fixed electrode plate 12 and insulator member 13 which are preferably integrally formed together.

Attachment means/rivet 17 as used in this first embodiment, is made from an electrically conductive material such as a brass metal member in a cylindrical shape with a hollow inside and a head member 17a.

Insulator 13 is formed in a generally block shape from an electrically insulating material with a high insulation factor and good high temperature properties such as a high temperature resin material. At the end of the insulator adjacent the open end of the protector, there is provided a through hole 13a through which rivet 17 is received extending throughout the entire length of through hole 13a. Around the lower portion of through hole 13a, an annular recess 13b receives the head 17a of rivet 17 which rests against shoulder 13e. This recess allows for the head 17a of rivet 17 to not protrude outside of insulator 13.

Fixed electrode plate 12 is preferably insert molded into the lower surface of insulator 13 at the time of forming the insulator. Fixed electrode plate 12 has a generally flat shape made from a metal with high electrical conductivity. At the one end generally adjacent the open end of protector casing 20, fixed electrode plate 12 has a terminal portion 12a extending from insulation member 13 for connection with electrical wire 2. The opposite end of plate 12 protrudes from the other end of insulator 13, with a tip portion having a protuberant fixed contact 12b attached thereto.

Fixed electrode plate 12 includes a deformed current carrying part 12c which is shaped to extend around through hole 13 and annular recess 13b of the insulator 13. This deformed part 12c is generally shaped like a cylinder with a wall leading to a curved reduced diameter central opening 12d in its top formed by a crimping operation. As is clearly shown in FIG. 4a, the cylinder has a diameter D1, a height of D2 and a reduced central opening diameter D3.

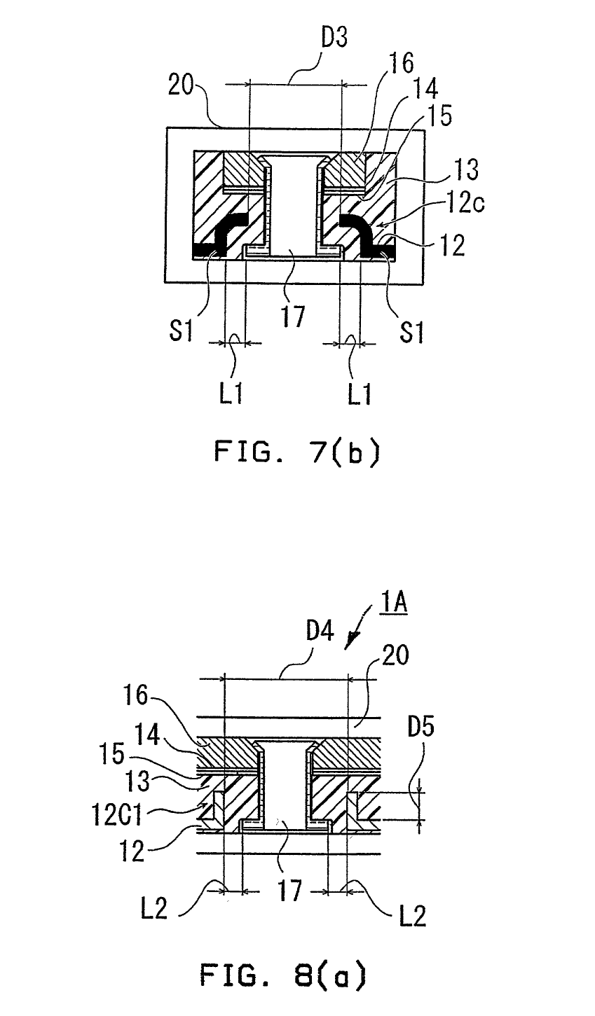

As is shown best in FIGS. 7(a) and 7(b), the values of outer diameter D1 and height D2 of deformed part 12c and the reduced central opening diameter D3 of reduced control opening 12d are determined so as to control the generation of heat that is produced in fixed electrode plate 12 as well as insure proper electrical isolation of rivet 17 from fixed electrode plate 12.

That is, the shape of deformed part 12c of fixed electrode plate 12 is determined so as to be able to permit the flow of a certain prescribed electric current while maintaining insulation distance L1 and minimizing heat build-up.

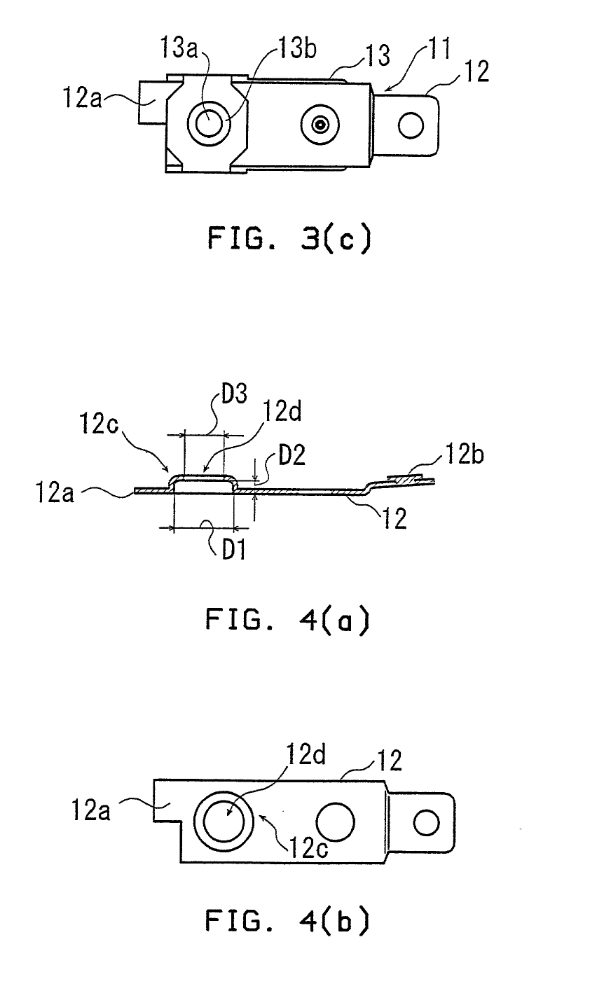

As is show in FIGS. 3(a) and 3(b), a receiving stand 13c is formed on the upper surface of insulator 13 to receive bimetal member 15. On both sides of receiving stand 13c are guide members 13d. The receiving stand 13c, guide members 13d along with movable electrode plate 14, bimetal member 15 and a holding plate 16 all work together to determine the precise positioning of these parts relative to one another. The parts are securely joined together by attachment member 17.

As is shown in 2(a) and 2(b), movable electrode plate 14 has a size which is approximately the same as the fixed electrode plate 12 and has a shape of a generally flat plate. At the end adjacent the open end of protector 1, movable electrode plate 14 has a connective terminal portion 14a which protrudes out from the protector generally parallel to connective terminal 12a of fixed electrode plate 12 which is connected to electrical wire 3. The front opposite end of movable electrode plate 14 is bent in the direction of fixed electrode plate 12 and has a movable contact 14b mounted on the distal end of movable electrode plate 14.

The movable contact 14b is positioned by the force exerted by holding part 16 and rivet 17 to be in contact with fixed contact 12b in the as assembled position.

Bimetal member 15 is typically composed of two metal members (although more may be used) with distinctly different rates of thermal expansion with a predetermined prescribed curved shape so as to snap from one curved position to an inverted curved position upon change in the temperature of the bimetal member.

Moreover, bimetal member 15 is positioned adjacent movable electrode plate 14 so that upon reaching a predetermined temperature the bimetal member will snap and cause the disengagement of movable contact 14b from fixed contact 12b thereby providing an open circuit. The bimetal member is precisely held at an attachment position by holding member 16 along with rivet 17 between movable electrode plate 14 and insulator 13. A hole sized to accommodate rivet 17 is provided in both movable plate 14 and bimetal member 15.

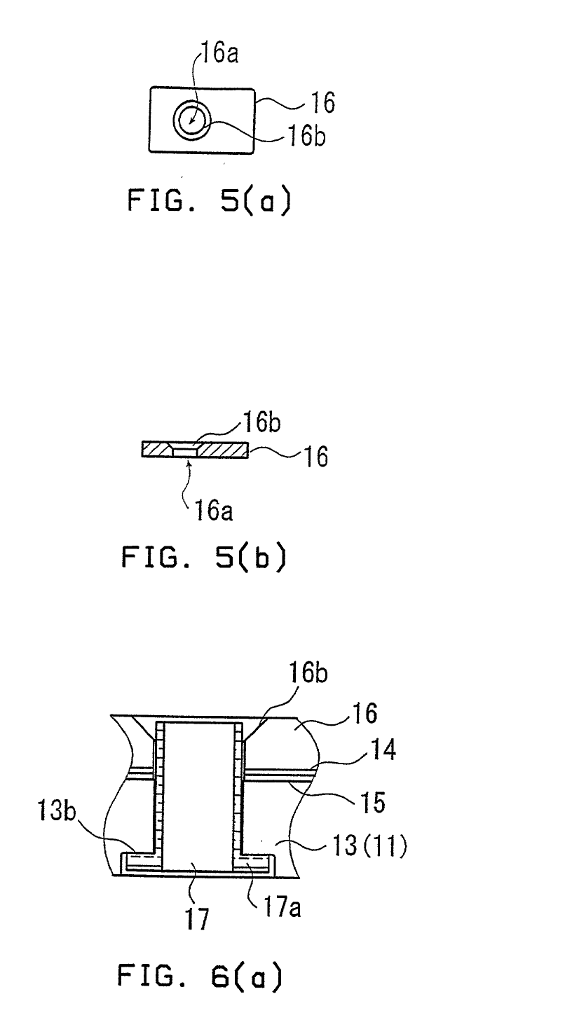

As is shown in FIGS. 5(a) and 5(b), the holding member 16 is made of metal and is generally of a rectangular shape to be received by insulator 13 and its guide part 13d. Moreover, a through hole 16a is provided in holding member 16 to accommodate rivet 17. A tapered portion 16b is provided at the top of through hole 16a to receive the open end portion of the rivet 17 as it is plastically deformed to lock all the individual components of protector assembly 10 together so that they can not move at the attachment point, one relative to the others.

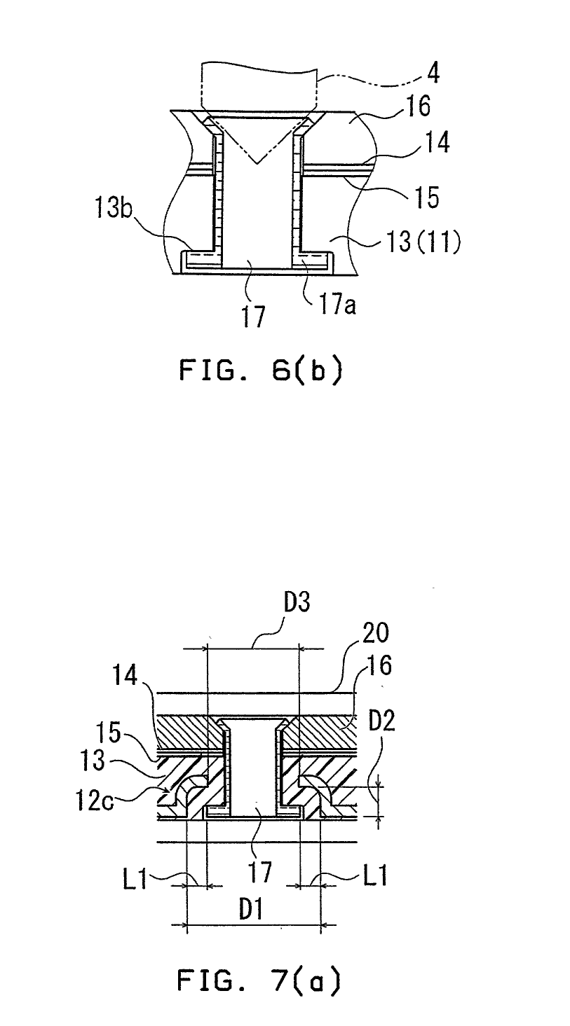

More specifically, rivet 17 with its head portion 17a flush against shoulder 13e of annular recess 13b (as shown in FIGS. 6(a) and 6(b)) is inserted through insulator 13, bimetal member 15, movable electrode plate 14 and holding member 16 in that order and then, by way of example, a swaging tool 4 is driven into the open end of rivet to deform its wall portion to conform to the shape of tapered portion 16b of holding member 16, thereby firmly holding the movable electrode plate 14, bimetal member 15 together at the attachment point without any gap between insulator 13 and holding member 16.

As is shown in FIG. 1, protector casing 20 is preferably closed at one end and its interior cavity is sized to snuggly accommodate protector assembly 10 without any gap. In this embodiment, the length of the rivet 17 is determined in such a fashion so that it will not protrude from the upper surface of holding member 16 or from lower surface of insulator 13.

In accordance with this invention as described above, the connective terminals 12a and 14a of protector 1 are connected in series with a motor (not shown) as part of the power source circuit for the motor. By way of example, connective terminal 12a of fixed electrode plate 12 is a plus terminal and connective terminal 14a of movable electrode plate is a minus terminal. When the motor is started the fixed electrode plate 12 and the movable electrode plate 14 of protector 1 form a closed current path for the power source circuit of the motor due to the engagement between fixed contact 12b and movable contact 14b.

In accordance with this invention, deformed part 12c of fixed electrode plate 12 has a sufficient electric insulating distance from rivet 17 so that there is no danger o electric “shorting” between fixed electrode plate 12 and rivet 17 which is typically in electrical communication with movable electrode plate 14.

That is, the electrical path flows from fixed electrode plate through movable electrode plate 14 during normal operation of the motor with the deformed part 12c of fixed electrode plate is electrically isolated from rivet 17.

In the case where the motor is heated excessively, bimetal member 15 is heated to its predetermined actuation temperature with the result that it snaps over center thereby disengaging movable contact 14b from fixed contact 12b. This act causes an open circuit condition from the power source circuit with the result that the motor (or the like) is shut down and protected.

In accordance with this invention, deformed part 12c of fixed electrode plate has a preselected size so as to permit the desired flow of current without becoming excessively heated. It has a predetermined cross sectional area S1 which is separated though a required insulating distance L1 from the rivet.

In accordance with this invention, both movable electrode plate 14 and bimetal member 15 are securely fixed by attachment means 17 which prevents the development of any shifting at the attachment point in the attachment positioning between plate 14 and bimetal member 15. Such stability in the attachment positions between these members is extremely important for an accurate, reliable protector.

In accordance with this invention moreover, fixed electrode plate 12 and insulator 13 are integrally formed together as fixed electrode 11 which increases the strength of electrode 11 itself and further improves the installation strength of movable electrode plate 14 and bimetal member 15 that are installed thereon.

In accordance with this invention, still further, the position of the various components is important to provide a compact protector with a sturdy, fixed protector assembly structure which is able to carry sufficient current without excessively heating and causing internal electrical shorting among the various parts. The prevention of heating in deformed part is also important in not causing erroneous actuation of bimetal member 15 which is not representative at motor operating conditions.

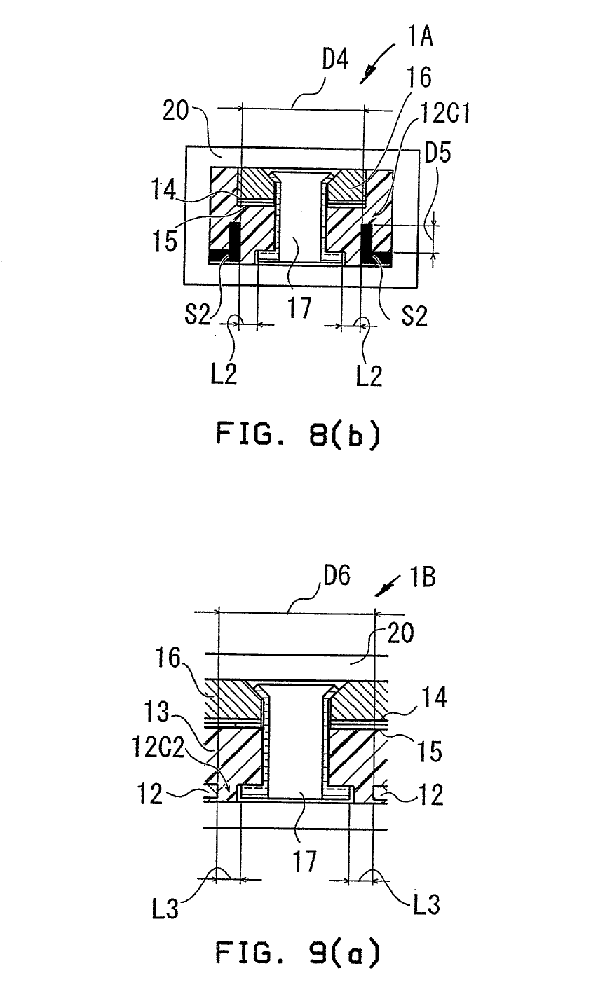

FIGS. 8(a) and 8(b) show a protector 1A which is an alternate second embodiment of this invention. Protector 1A is identical to protector 1 of the first embodiment except it has a different deformed part 12c1 of fixed electrode plate 12.

In this embodiment, the deformed part 12c1 of electrode plate 12 is shaped like a straight walled cylinder having an opening with a diameter D4 and a length D5. An insulator distance L2 is provided to ensure that there is no short circuitry between deformed part 12c1 and attachment means 17. In general the preselected area size of current passing cross section S2 and insulation distance L2 are the same as in the first embodiment. In all other respects, this embodiment would be identical to the first embodiment of this invention.

A protector made using deformed part 12c1 is easier to be made integrally with insulator 13 whereas a protector using deformed part 12c generally provides stronger adherence between fixed electrode plate 12 and insulator 13 when integrally formed together.

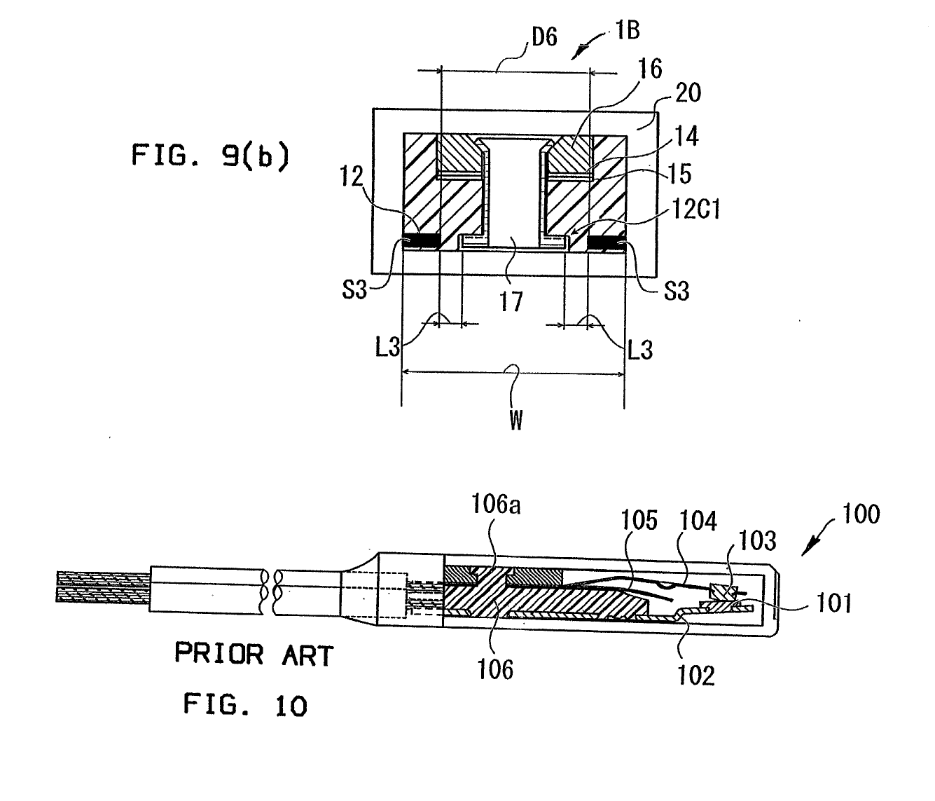

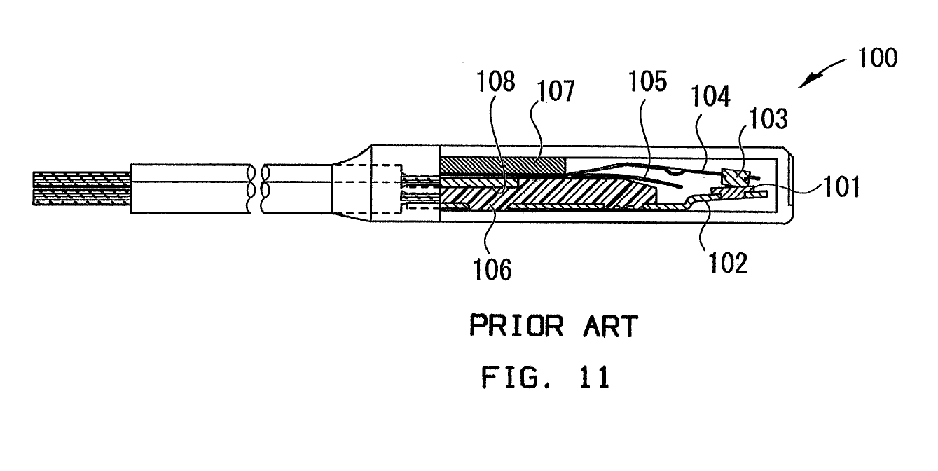

FIGS. 9(a) and 9(b) show a protector 1B which is an alternate third embodiment of this invention. Protector 1B is identical to protector 1 of the first embodiment and protector 1A of the second embodiment except for the shape of the deformed electricity carrying part 12C2 of fixed electrode plate 12.

In this embodiment, deformed part 12c2 of fixed electrode plate 12 is formed by making a circular hole of a prescribed outer diameter D6 in fixed electrode plate 12 by punch method, etc. In general, this shaped part can only be used where the width W of plate 12 is large so as to provide for a sufficient current passing cross section S3 even after allowing insulation distance L3. This configuration has the advantage of simple, low cost processing.

The forms of implementation of this invention have been explained above. It is obvious that the range of applicability of this invention is not restricted to those items which have been shown in the above embodiments. For example, it would be possible to use an attachment means (rivet) and deformed current carrying part of fixed electrode plate also in the case where only a snap acting movable electrode plate is fixed on the insulator. Additionally, a solid rivet could be used in place of hollow rivet described above.

What is claimed:

1. An electrical protector device comprising a fixed electrode that has a fixed contact mounted thereon, a movable electrode that has a movable contact mounted thereon, said movable contact positioned to be able to make and to break contact with said fixed contact, a heat responsive bimetal member positioned directly adjacent said movable electrode which moves from a first position to a second position upon being heated to a prescribed temperature for causing either the engagement or the disengagement of said fixed contact and said movable contact, an insulator member which electrically insulates both said movable electrode and said bimetal member from said fixed electrode and an attachment member capable of being inserted into part of said insulator to securely fix both said movable electrode and said bimetal member on said insulator at an attachment point thereby allowing for essentially no relative movement between the movable electrode and the bimetal member at said attachment point.

2. A protector device as set forth in claim 1 in which said fixed electrode has an opening therein for receiving said attachment member and a deformed electricity carrying portion having sufficient size to carry a prescribed electric current without overheating while maintaining a prescribed insulation distance from said attachment member to prevent electrical shorting between the two.

3. A protector device as set forth in claim 2 in which said deformed electricity carrying portion has a curved wall shape with a central opening.

4. A protector device as set forth in claim 2 in which said deformed electricity carrying portion has a generally cylindrical shape with a central opening.

5. A protector device as set forth in claim 2 in which said fixed electrode and insulator are formed integrally together with said insulator having a through hole adapted for receipt of said attachment member with said deformed electricity carrying portion positioned to carry electric current around said through hole.

6. A protector as set forth in claim 1 further including a holding member, said holding member aligned with at least a portion of said insulator member to sandwich said movable electrode and said bimetal member between them.

7. A protector device as set forth in claim 1 wherein said attachment member is a rivet.

8. A protector device as set forth in claim 7 further including a holding member, said holding member, movable electrode, bimetal member and insulator all having an aligned through hole for receipt of said rivet to securely fix them together at said attachment point.

9. A protector device as set forth in claim 8 in which said rivet has such a length as to not protrude from either the insulator at one end or the holding member on the other end in an assembled device.

10. A protector as set forth in claim 1 further including a casing member to fixedly house said fixed electrode, said movable electrode, said bimetal member, said insulator member and said attachment member.

11. An electrical protector device especially useful for protecting an electrical motor comprising a casing for housing a protector assembly, said protector assembly comprising a fixed electrode that has a fixed contact mounted thereon, a movable electrode that has a movable contact mounted thereon, said movable contact positioned to be able to make and to break contact with said fixed contact, a heat responsive bimetal member positioned directly adjacent said movable electrode which moves from a first position to a second position upon being heated to a prescribed temperature for causing either the engagement or the disengagement of said fixed contact and said movable contact, an insulator member which electrically insulates both said movable electrode and said bimetal member from said fixed electrode, a holding member aligned with at least a portion of said insulator member to sandwich said movable electrode and said bimetal member between them and an attachment member capable of being inserted into part of said insulator and said holding member to securely fix both said movable electrode and said bimetal member on said insulator at an attachment point thereby allowing for essentially no relative movement between the movable electrode and the bimetal member at said attachment point.

12. A protector device as set forth in claim 11 in which said fixed electrode has an opening therein for receiving said attachment member and a deformed electricity carrying portion having sufficient size to carry a prescribed electric current without overheating while maintaining a prescribed insulation distance from said attachment member to prevent electrical shorting between the two.

13. A protector device as set forth in claim 12 in which said deformed electricity carrying portion has a curved wall shape with a central opening.

14. A protector device as set forth in claim 13 in which said deformed electricity carrying portion has a generally cylindrical shape with a central opening.

15. A protector device as set forth in claim 12 in which said fixed electrode and insulator are formed integrally together with said insulator having a through hole adapted for receipt of said attachment member with said deformed electricity carrying portion positioned to carry electric current around said through hole.

16. A protector device as set forth in claim 11 wherein said attachment member is a rivet.

17. A protector according to claim 16 wherein said rivet has a hollow tubular body open at one end.
